(19) United States
(12) Patent Application Publication
(10) Pub. No.: US 2016/0072208 A1
(43) Pub. Date: Mar. 10, 2016

(54) ELECTRICAL CONNECTOR

(71) Applicant: FOXCONN INTERCONNECT TECHNOLOGY LIMITED, Grand Cayman (KY)

(72) Inventors: XIN-LEI LI, Kunshan (CN); JIAN-KUANG ZHU, Kunshan (CN)

(21) Appl. No.: 14/846,810

(22) Filed: Sep. 6, 2015

(30) Foreign Application Priority Data
Sep. 5, 2014 (CN) 201420510560.7

(51) Int. Cl. H01R 12/70; H01R 13/6594

(52) U.S. Cl. CPC H01R 12/7076; H01R 13/6594

(57) ABSTRACT

An electrically connector includes an insulative housing, a plurality of contacts disposed in the housing, a metallic shield enclosing the housing, wherein a mating cavity communicating with an exterior in the front-to-back direction, is formed by the shield in the vertical direction perpendicular to the front-to-back direction while optimally by a pair of reinforcement arms of the housing in the transverse direction perpendicular to both the front-to-back direction and the vertical direction. The whole connector is supported upon the printed circuit board by not only a pair of mounting pads stamped/split from the shield but also two lateral side widened sections of the shield which are respectively neighboring the pair of mounting pads in the transverse direction and located under the pair of optional reinforcement arms of the housing in the vertical direction.

### BACKGROUND OF THE INVENTION

1. Field of the Invention

The present invention relates generally to an electrical connector, and particularly to a sink type electrical connector.

2. Description of Related Arts

The traditional electrical sink type electrical connector is essentially to use the supporting/mounting pads stamped from the metallic shield to support the whole electrical connector upon the printed circuit board wherein a lower portion of the mating cavity is located within a notch of the printed circuit board. Such a design may be feasible for the small sized connector; anyhow, for a long/large sized docking connector in the transverse direction it is relatively insufficient to obtain the reliable support only via the supporting pads split/stamped from the metallic shield at two opposite lateral sides. Under such a condition, the solder connection between the contact tails and the printed circuit board may improperly endure a relatively larger stress disadvantageously.

A new sink type connector with a relatively large size, is desired.

### SUMMARY OF THE INVENTION

Accordingly, an object of the present invention is to provide a sink type electrical connector for mounting into a notch of the printed circuit board, including an insulative housing, a plurality of contacts disposed in the housing, a metallic shield enclosing the housing, wherein a mating cavity communicating with an exterior in the front-to-back direction, is formed by the shield in the vertical direction perpendicular to the front-to-back direction while optimally by a pair of reinforcement arms of the housing in the transverse direction perpendicular to both the front-to-back direction and the vertical direction. In essence, the whole connector is supported upon the printed circuit board by not only a pair of mounting pads stamped/split from the shield but also two lateral side widened sections of the shield which are respectively neighboring the pair of mounting pads in the transverse direction and located under the pair of optional reinforcement arms of the housing in the vertical direction.

Understandably, compared with the aforementioned prior art, in the instant invention because the support along the transverse direction is provided by both the traditional mounting pads derived from the shield but also the two lateral side regions of the lower plate of the shield adjacent to the pair of mounting pads in a reinforced manner, no improper impact due to external forces may jeopardize the solder connection between the contact tails and the printed circuit board.

### BRIEF DESCRIPTION OF THE DRAWINGS

FIG. 1 is a front downward assembled perspective view of a preferred embodiment of an electrical connector according o the invention;

FIG. 2 is a downward assembled perspective view of the electrical connector of FIG. 1 in an upside-down manner;

FIG. 3 is a front exploded perspective view of the electrical connector of FIG. 1;

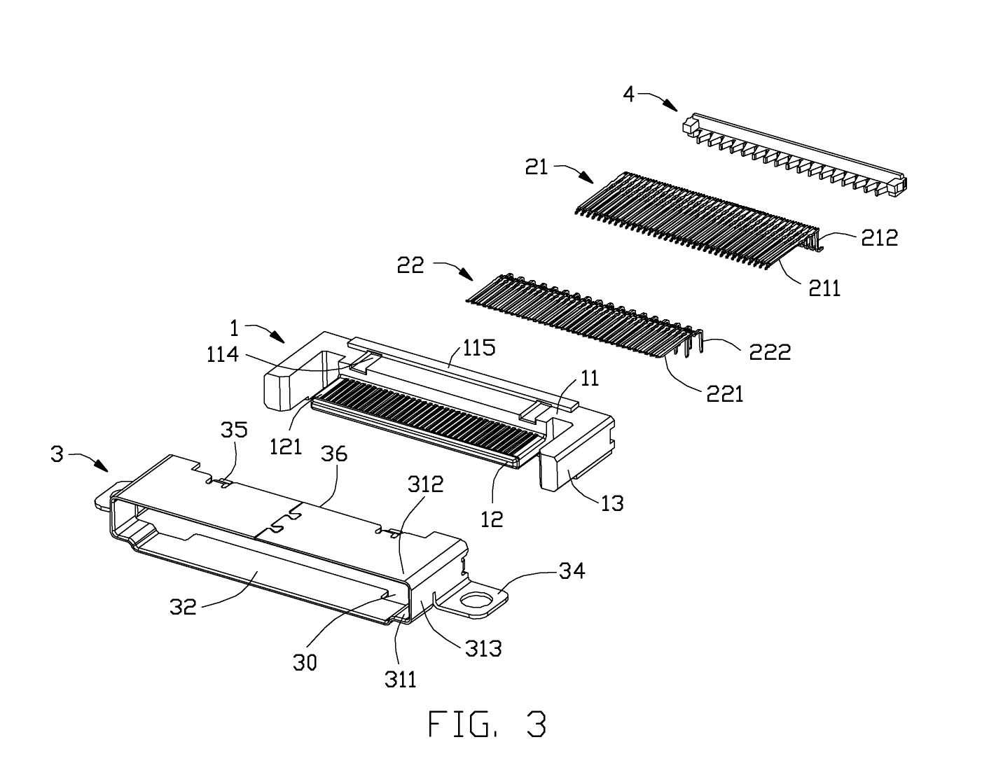

FIG. 4 is a further exploded perspective view of the electrical connector of FIG. 3;

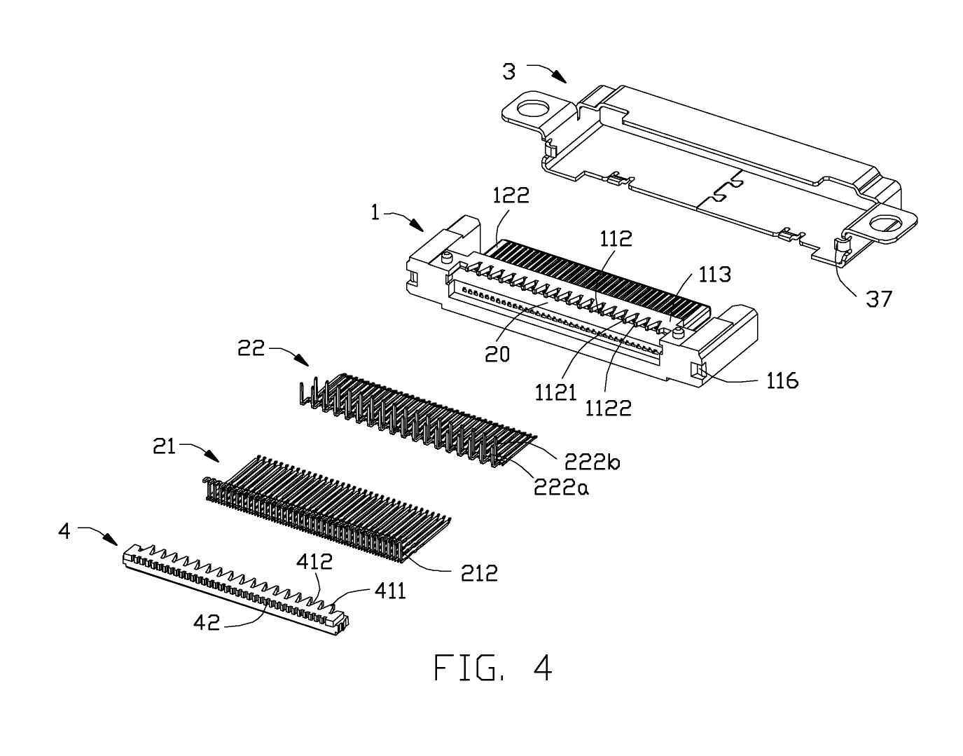

FIG. 5 is a front downward perspective view of the electrical connector of FIG. 4 mounted upon the printed circuit board as an electrical connector assembly;

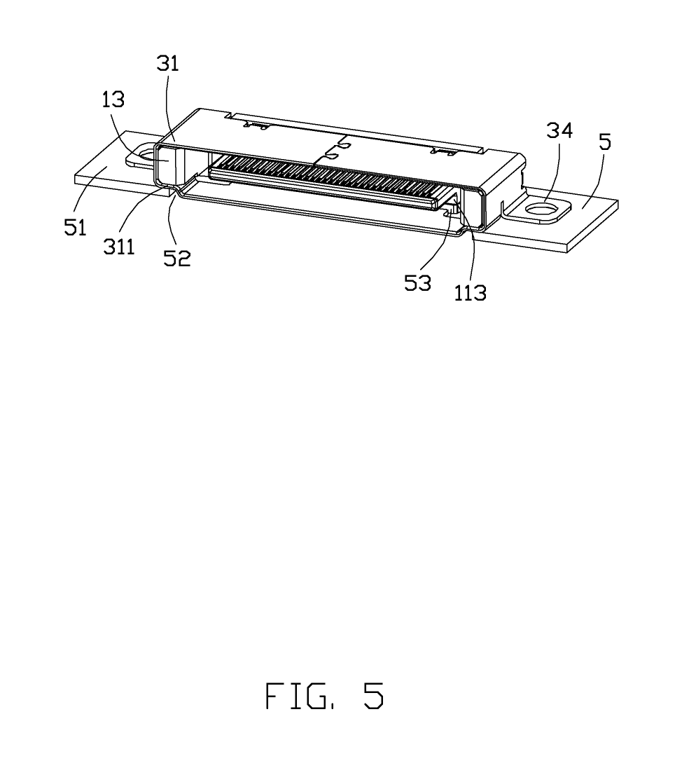

FIG. 6 is a downward perspective view of the electrical connector of FIG. 4 mounted upon the printed circuit board as an electrical connector assembly in an upside-down manner;

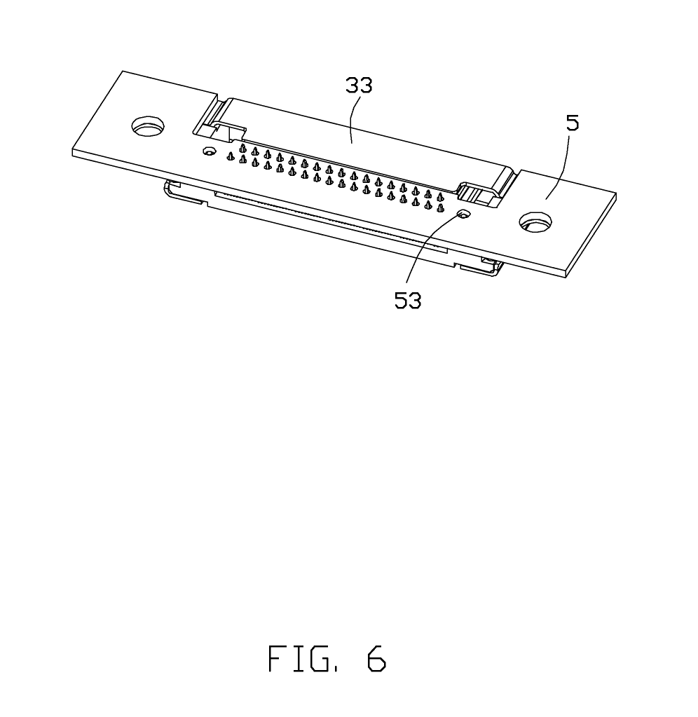

### DETAILED DESCRIPTION OF THE PREFERRED EMBODIMENT

Reference will now be made in detail to the preferred embodiment of the present invention.

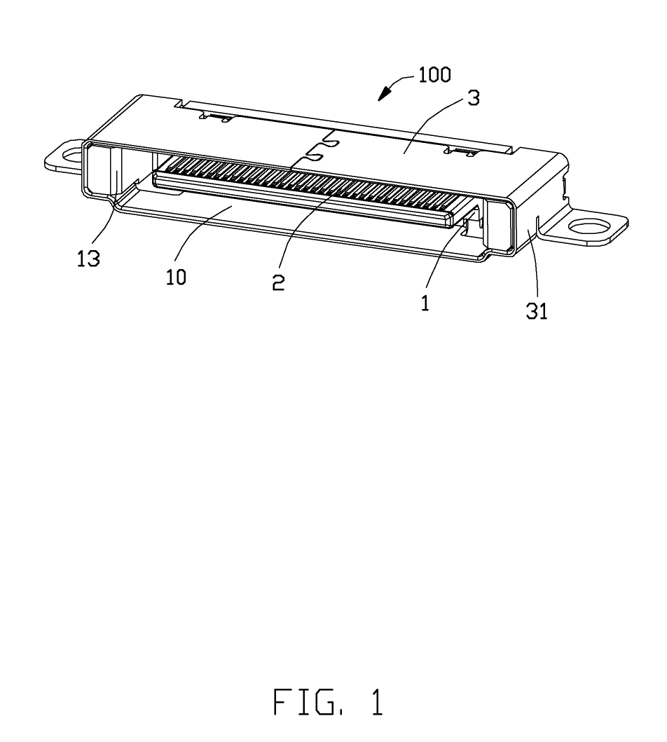

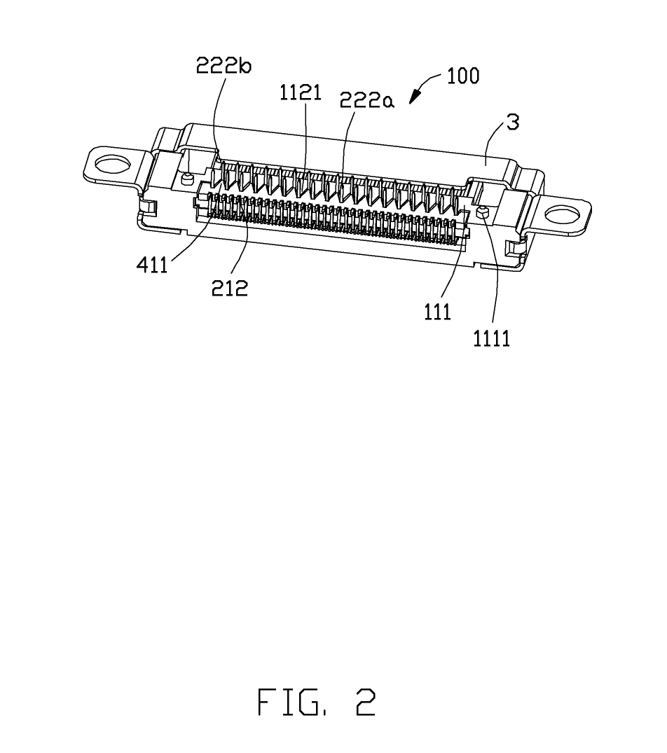

Referring to FIGS. 1-2, an electrical connector assembly includes an electrical connector 100, for mounting upon a printed circuit board 5, which could be a relative large/long sink type electrical connector in a stably supporting manner. The electrical connector 100 includes an insulaitve housing 1, a plurality of contacts 2 disposed in the housing 1, and a metallic shield 3 enclosing the housing 1. A mating cavity 10 is formed in the shield 3 and communicates forwardly with an exterior in the front-to-back direction. A pair of widened/side regions 31 formed by the shield 3 are located by two lateral sides of the mating cavity in the transverse direction. The pair of widened sections 31 are of a lying U-shaped structures opposite to each other and communicating to the mating cavity in the transverse direction. Corresponding, the housing 1 includes a pair o reinforcement arms 13 received within the pair of corresponding widened sections 31, respectively.

The housing 1 includes a base 11 and a mating tongue 12 extending from the base 11 into the mating cavity 10. A mounting surface 111 is formed on an underside of the base 11. The pair of reinforcement arms 13 forwardly in the front-to-back direction extend from two opposite transverse ends of the base 11, respectively. The mating tongue 12 is spaced from the pair of supporting arms 13 in the transverse direction and forms opposite first plane 121 and second surface 122.

The contacts include a plurality of first contacts 21 and a plurality of second contacts 22 which may be assembled into or integrally formed within the housing 1. Each first contact 21 includes a first contacting section 211 on the first surface 121 and a first mounting section 212 exposed outside of a rear side of the housing 1. Each second contact 22 includes a second contacting section 221 on the second surface 122 and a second mounting section 222 exposed outside of the rear side of the housing 1. Notably, in this embodiment the second mounting sections 222 of the second contacts 22 are arranged with the second mounting sections 222a and 222b alternately arranged with each other in two rows and mounted to the printed circuit board 5 in a surface mounting manner while the first mounting sections 212 are located behind the second mounting sections 222 and soldered to the printed circuit board 5 in a through hole manner.

A spacer 4 for regulating the first mounting sections 212 and the second mounting sections 222, is forwardly inserted into and received within an accommodating recess 20 in the rear side of the housing 1 via a pair of corresponding side grooves (not labeled) in the base 11. The base 11 includes a retaining section 112 of a saw-tooth structure. The first fixing section 112 includes a plurality of protrusions 1121 and a plurality of recessions 1122 alternately arranged with each other along the transverse direction. Correspondingly, the spacer 4 includes a plurality of second protrusions 411 and a plurality of second recessions 412 alternately arrange with each other in the transverse direction to match the first recessions 1122 and the second protrusions 1121, respectively. Notably, the second mounting sections 222a are respectively pressed by the corresponding first protrusions 1121 in the second recessions 412 while the second mounting sections 222b are respectively pressed by the corresponding second protrusions 411 in the corresponding first recessions 1122. The spacer 4 forms a plurality of grooves 42 to retain the corresponding first mounting sections 212, respectively.

The base 11 forms an upward protruding bar 115 and a pair of slots 114 extending rearwardly under the upward protruding 115. Correspondingly, the shield 3 includes an abutment recess 36 to receive the protruding bar 115, and a pair of retaining tangs 35. The base 11 further forms a pair of locking recesses 116 to receive the pair of corresponding locking tabs 37. Via the foregoing structures, the shield 3 is secured to the housing 1. The shield 3 includes a lower plate 32 linked between the pair of widened sections 31 and located at a level below the pair of widened sections 31 and the aforementioned mounting surface 111 of the base 11. The widened section 31 includes a supporting plate 311, an upper plate 312 and a side/connecting plate 313 between the supporting plate 311 and the upper plate 312 to commonly define a receiving space 30 to receive the corresponding reinforcement arm 13 wherein the upper plate 312 is parallel to the supporting plate 311 optimally. Alternately, other cross-sectional shape may be applied to the widened section 31 instead of the lying U-shaped structure, as long as a supporting plate, which is a part of the frame structure in a cross-sectional view, is adapted to downwardly abut against the printed circuit board 5 either fully or partially.

Notably, in this embodiment the mating cavity 10 and the pair of receiving spaces 30 by two sides are essentially communicative with each other in the transverse direction, Understandably, the mating cavity 10 is of a standard configuration/dimension for mating to a plug connector, so the pair of widened sections 31 and the corresponding reinforcement arms 13 are essentially additional to the traditional standard connector and should not invade such a mating cavity 10 in the transverse direction. Understandably, in this embodiment the reinforcement arm 13 is to not only strengthen the widened sections 31 for resist the downward forces against the printed circuit board 5 but also to provide restriction with regard to the mated plug connector in the transverse direction even though the offset structure (not labeled) between the lower plate 32 and the supporting plate 311 already provides such restriction in the transverse direction. Anyhow, in an alternate embodiment, the reinforcement arm 13 may be removed not to reinforce the widened sections 31 if the shield 3 is made by the relative stiff material. Under such situation, a restriction tab may be split from the widened section 31 to extend into the receiving space 30 for forming the restriction structure in the transverse direction for the mated plug connector which is received in the mating cavity 10.

The printed circuit board 5 includes a supporting surface 51 with a forwardly exposed notch 52. The widened section 31 is supportably mounted upon the supporting surface 51. On the other hand, the mounting surface 111 is formed by the undersurface of the base 11 and the undersurface of the spacer 4 to be supportably mounted upon the supporting surface 51 too. A pair of mounting posts 1111 are received within the corresponding mounting holes 53 in the printed circuit board 5. The lower plate 32 is essentially received within the notch 52 so as to have the bottom face 33 of the lower plate 32 is coplanar with a bottom face of the printed circuit board 5. As the traditional connector, the shield 3 further includes a pair of mounting pads 34 stamped and split therefrom on two lateral sides for mounting to the supporting surface 51. In this embodiment, the base 11 forms a step structure 113 around the supporting surface 111 and the printed circuit board 5 forms another step structure compliantly in the vertical direction.

Understandably, the mating tongue 12 is essentially located at the middle level of the mating cavity 10, and the lower plate 32 is lower than reinforcement arm 13. Therefore, the mating tongue is essentially located lower than the middle level of the reinforcement arm 13. Notably, in this embodiment the mating cavity 10 is defined by the opposite top plate (not labeled), which is opposite to the lower plate 32 and essentially coplanar with the upper plate 312, and lower plate 32 in the vertical direction and the opposite reinforcement arms 13 each of which is enclosed in the receiving space 30 of the corresponding widened sections 31 in the transverse direction wherein the dimension of the mating cavity 10 in the vertical direction is smaller than that of the receiving space 30. Understandably, the mating cavity 10 for receiving the plug connector does not include the pair of receiving spaces 30 which are located by two lateral sides of the mating cavity 10 to optionally receive the corresponding reinforcement arms 13. From another viewpoint, the shield 3 essentially defines a frame structure, in a front view, essentially composed of the opposite top plate (not labeled) and lower plate 32, and the opposite widened sections 31 to enclose both the mating cavity 10 and the pair of receiving spaces 30 wherein the supporting plate 311 is a part of the frame structure while the mounting pad 34 extends outwardly and laterally from the frame structure opposite to the corresponding supporting plate 311 along the transverse direction in a coplanar manner. From another viewpoint, the dimension of the receiving space 30 of the widened sections 31 along the front-to-back direction is essentially similar to that of the mating cavity 10. This feature assures sufficient support compared with the less dimensioned mounting pad used in the traditional sink type connector.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. An electrical connector for mounting to a printed circuit board with a notch around an edge region and for mating with a plug connector, comprising:
an insulative housing;
a plurality of contacts disposed in the housing; and
a metallic shield enclosing said housing and defining a frame structure in a front view along a front-to-back direction, said frame structure including opposite top and lower plates in a vertical direction perpendicular to said front-to-back direction, and a pair of widened sections located on two sides of the frame structure in a transverse direction perpendicular to both said front-to-back direction and said vertical direction; wherein
the pair of widened sections are adapted to be mounted upon a mounting surface of the printed circuit board while the lower plate is lower than the widened sections and adapted to be received within the notch of the printed circuit board.

2. The electrical connector as claimed in claim 1, wherein a mating cavity, in which the contacts are exposed, for compliantly receiving the plug connector, is defined between the top plate and the lower plate in the vertical direction, and each of said pair of widened sections defines a receiving space beside the mating cavity without capability of receiving any part of the plug connector therein.

3. The electrical connector as claimed in claim 2, wherein a dimension between the top plate and the lower plate in the vertical direction is larger than that in the widened section.

4. The electrical connector as claimed in claim 2, wherein the housing includes a pair of reinforcement arms received in the corresponding widened sections, respectively.

5. The electrical connector as claimed in claim 2, wherein the housing includes a mating tongue extending forwardly into the mating cavity, and the mating tongue is located at a level which is lower than a middle level of the receiving space in the vertical direction.

6. The electrical connector as claimed in claim 1, wherein the shield further includes a pair of mounting pads laterally and outwardly extending from two opposite side plates of the corresponding widened sections, each of said widened sections includes a supporting plate for being seated upon the mounting surface of the printed circuit board, and the supporting plate is coplanar with the corresponding mounting pad.

7. The electrical connector as claim 6, wherein an offset structure is formed between each supporting plate of the corresponding widened section and the lower plate for restraining relative movement of the plug connector in the mating cavity along the transverse direction.

8. An electrical connector assembly for mating with a plug connector, comprising:
a printed circuit board defining opposite supporting surface and undersurface in a vertical direction, and a notch formed in an edge thereof;
an electrical connector including:
an insulative housing;
a plurality of contacts disposed in the housing;
a metallic shield enclosing the housing and forming a frame structure, in a front view along a front-to-back direction perpendicular to said vertical direction, the frame structure including:
a pair of widened sections at two opposite ends in a transverse direction perpendicular to both said vertical direction and said front-to-back direction, each of said widened sections including a side connecting plate and a supporting plate located inside the corresponding side connecting plate and seated upon the supporting surface adjacent to the notch, and
a lower plate linked between two opposite lower plates of the corresponding pair of widened sections; wherein
the lower plate is located at a level lower than the opposite lower plates in said vertical direction, and is received within the notch.

9. The electrical connector assembly as claimed in claim 8, wherein a bottom face of lower plate is coplanar with an undersurface of the printed circuit board.

10. The electrical connector assembly as claimed in claim 8, wherein an offset structure is formed between the lower plate and the supporting plate.

11. The electrical connector assembly as claimed in claim 8, wherein each of said widened sections forms a receiving space to receive a corresponding reinforcement arm of the housing.

12. The electrical connector assembly as claimed in claim 8, wherein each of said widened sections forms a receiving space and the frame structure forms a mating cavity for receiving a plug connector without involvement of said receiving space.

13. The electrical connector assembly as claimed in claim 8, where either housing or the shield forms a pair of mounting pads extending laterally and outwardly beside the corresponding side connecting plate and being coplanar with the supporting plates to be seated upon the supporting surface of the printed circuit board.

14. An electrical connector for mounting to a supporting surface of printed circuit board with a notch in an edge region and for mating with a plug connector, comprising:
an insulative housing;
a plurality of contacts disposed in the housing;
a metallic shield enclosing the housing and defining a mating cavity in which the contacts are exposed, said mating cavity communicating forwardly with an exterior along a front-to-back direction for compliantly mating with the plug connector;
a pair of widened sections located by two lateral sides of the mating cavity in a transverse direction perpendicular to said front-to-back direction, each of said widened sections including a supporting plate for being seated upon the supporting surface; and
a lower plate located between the pair of widened sections and below each supporting plate in a vertical direction perpendicular to both said front-to-back direction and said transverse direction for being received within the notch; wherein a dimension of each of said widened sections along said front-to-back direction is similar to that of the mating cavity.

15. The electrical connector as claimed in claim 14, wherein the widened sections are configured away from the mating cavity for not contacting the plug connector.

16. The electrical connector as claimed in claim 14, wherein said widened sections are integrally formed with the shield.

17. The electrical connector as claimed in claim 16, wherein each of said widened sections defines a receiving space communicating with the mating cavity in the transverse direction.

18. The electrical connector as claimed in claim 17, wherein the housing forms a pair of reinforcement arms each extending into the corresponding receiving space.

19. The electrical connector as claimed in claim 18, wherein a dimension of the mating cavity in the vertical direction is larger than that of the receiving space.

20. The electrical connector as claimed in claim 16, wherein said shield further forms a pair of mounting pads respectively outside of the corresponding widened sections and being opposite to but coplanar with the supporting plates for mounting to the supporting surface.
